(19) United States
(12) Patent Application Publication
(10) Pub. No.: US 2024/0156177 A1
(43) Pub. Date: May 16, 2024

(54) POWER SUPPLY DEVICE AND AEROSOL-GENERATING SYSTEM INCLUDING THE SAME

(71) Applicant: KT&G CORPORATION, Daejeon (KR)

(72) Inventors: Daenam HAN, Seoul (KR); Seoksu JANG, Seoul (KR); Seungwon LEE, Gwangmyung-si Gyeonggi-do (KR); Sungwook YOON, Suwon-si Gyeonggi-do (KR); Yonghwan KIM, Anyang-si Gyeonggi-do (KR)

(73) Assignee: KT&G CORPORATION, Daejeon (KR)

(21) Appl. No.: 18/280,647

(22) PCT Filed: Dec. 24, 2021
(86) PCT No.: PCT/KR2021/019880

§ 371 Date: Sep. 6, 2023

(30) Foreign Application Priority Data
Jan. 4, 2021 (KR) 10-2021-0000467

(51) Int. Cl. A24F 40/95; A24F 40/57; A24F 40/65; H02J 7/00; H05B 1/02

(52) U.S. Cl. CPC A24F 40/95; A24F 40/57; A24F 40/65; H02J 7/0048; H05B 1/0252

(57) ABSTRACT

A power supply device and an aerosol-generating system including the same are disclosed. The power supply device includes a housing having formed therein an accommodation space, a power supply battery, a power input terminal for receiving power from the outside, a power output terminal for outputting power to an aerosol-generating device accommodated in the accommodation space, a power circuit for transmitting power to the power supply battery or the power output terminal, and a controller for controlling the operation of the power circuit. The controller determines the remaining capacity of a device battery of the aerosol-generating device. When the remaining capacity is less than a predetermined reference capacity, the controller controls the power circuit to transmit power to the power output terminal. When the remaining capacity is equal to or greater than the reference capacity, the controller controls the power circuit to transmit power to the power supply battery.

### TECHNICAL FIELD

The present disclosure relates to a power supply device and an aerosol-generating system including the same.

### BACKGROUND ART

An aerosol-generating device is a device that extracts certain components from a medium or a substance by forming an aerosol. The medium may contain a multicomponent substance. The substance contained in the medium may be a multicomponent flavoring substance. For example, the substance contained in the medium may include a nicotine component, an herbal component, and/or a coffee component. Recently, various research on aerosol-generating devices has been conducted.

Recently, various research on aerosol-generating devices has been conducted. Also, research on a power supply device for charging a battery of an aerosol-generating device has been conducted.

### DISCLOSURE OF INVENTION

### Technical Problem

It is an object of the present disclosure to solve the above and other problems.

It is another object of the present disclosure to provide a power supply device, which is capable of determining whether to supply power to an aerosol-generating device in consideration of the state of a battery of the aerosol-generating device, and an aerosol-generating system including the same.

### Solution to Problem

A power supply device according to various embodiments of the present disclosure for accomplishing the above and other objects may include a housing having formed therein an accommodation space, a power supply battery, a power input terminal configured to receive power supplied from the outside, a power output terminal configured to output power to an aerosol-generating device accommodated in the accommodation space, a power circuit configured to transmit the power received through the power input terminal to one of the power supply battery or the power output terminal, and a controller configured to control the operation of the power circuit. The controller may determine the remaining capacity of a device battery included in the aerosol-generating device. When the remaining capacity is less than a predetermined reference capacity, the controller may control the power circuit to transmit the power received through the power input terminal to the power output terminal. When the remaining capacity is equal to or greater than the reference capacity, the controller may control the power circuit to transmit the power received through the power input terminal to the power supply battery.

An aerosol-generating system according to various embodiments of the present disclosure for accomplishing the above and other objects may include a power supply device and an aerosol-generating device. The power supply device may include a housing having an accommodation space formed therein to accommodate the aerosol-generating device, a power supply battery, a power input terminal configured to receive power supplied from the outside, a power output terminal configured to output power to the aerosol-generating device accommodated in the accommodation space, a power circuit configured to transmit the power received through the power input terminal to one of the power supply battery and the power output terminal, and a first controller. The aerosol-generating device may include a heater, a device battery configured to supply power to the heater, and a second controller. The first controller may determine the remaining capacity of the device battery. When the remaining capacity is less than a predetermined reference capacity, the first controller may control the power circuit to transmit the power received through the power input terminal to the aerosol-generating device through the power output terminal. When the remaining capacity is equal to or greater than the reference capacity, the first controller may control the power circuit to transmit the power received through the power input terminal to the power supply battery.

### Advantageous Effects of Invention

According to at least one of embodiments of the present disclosure, power supplied from the outside may be appropriately supplied to an aerosol-generating device in consideration of the state of a battery of the aerosol-generating device.

Additional applications of the present disclosure will become apparent from the following detailed description. However, because various changes and modifications will be clearly understood by those skilled in the art within the spirit and scope of the present disclosure, it should be understood that the detailed description and specific embodiments, such as preferred embodiments of the present disclosure, are merely given by way of example.

### BRIEF DESCRIPTION OF DRAWINGS

The above and other objects, features, and other advantages of the present disclosure will be more clearly understood from the following detailed description taken in conjunction with the accompanying drawings, in which:

FIG. 1 is a block diagram of an aerosol-generating device according to an embodiment of the present disclosure;

FIGS. 2A to 4 are views for explaining an aerosol-generating device according to embodiments of the present disclosure;

FIG. 5 is a block diagram of a power supply device according to an embodiment of the present disclosure;

FIGS. 6A to 7 are views for explaining a power supply device according to embodiments of the present disclosure;

FIG. 8 is a flowchart showing an operation method of a power supply device according to an embodiment of the present disclosure; and

FIG. 9 is a flowchart showing an operation method of a power supply device according to another embodiment of the present disclosure.

### BEST MODE FOR CARRYING OUT THE INVENTION

Hereinafter, the embodiments disclosed in the present specification will be described in detail with reference to the accompanying drawings. The same or similar elements are denoted by the same reference numerals even though they are depicted in different drawings, and redundant descriptions thereof will be omitted.

In the following description, with respect to constituent elements used in the following description, the suffixes “module” and “unit” are used only in consideration of facilitation of description. The “module” and “unit” are do not have mutually distinguished meanings or functions.

In addition, in the following description of the embodiments disclosed in the present specification, a detailed description of known functions and configurations incorporated herein will be omitted when the same may make the subject matter of the embodiments disclosed in the present specification rather unclear. In addition, the accompanying drawings are provided only for a better understanding of the embodiments disclosed in the present specification and are not intended to limit the technical ideas disclosed in the present specification. Therefore, it should be understood that the accompanying drawings include all modifications, equivalents, and substitutions within the scope and sprit of the present disclosure.

It will be understood that the terms “first”, “second”, etc., may be used herein to describe various components. However, these components should not be limited by these terms. These terms are only used to distinguish one component from another component.

It will be understood that when a component is referred to as being “connected to” or “coupled to” another component, it may be directly connected to or coupled to another component. However, it will be understood that intervening components may be present. On the other hand, when a component is referred to as being “directly connected to” or “directly coupled to” another component, there are no intervening components present.

As used herein, the singular form is intended to include the plural forms as well, unless the context clearly indicates otherwise.

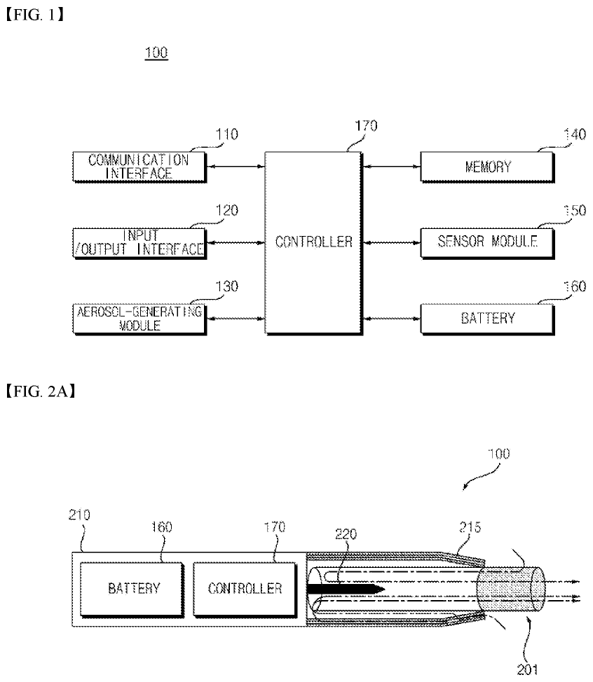

FIG. 1 is a block diagram of an aerosol-generating device according to an embodiment of the present disclosure.

Referring to FIG. 1, an aerosol-generating device 100 may include a communication interface 110, an input/output interface 120, an aerosol-generating module 130, a memory 140, a sensor module 150, a battery 160, and/or a controller 170.

In one embodiment, the aerosol-generating device 100 may be composed only of a main body. In this case, components included in the aerosol-generating device 100 may be located in the main body. In another embodiment, the aerosol-generating device 100 may be composed of a cartridge, which contains an aerosol-generating substance, and a main body. In this case, the components included in the aerosol-generating device 100 may be located in at least one of the main body or the cartridge.

The communication interface 110 may include at least one communication module for communication with an external device and/or a network. For example, the communication interface 110 may include a communication module for wired communication, such as a Universal Serial Bus (USB). For example, the communication interface 110 may include a communication module for wireless communication, such as Wireless Fidelity (Wi-Fi), Bluetooth, Bluetooth Low Energy (BLE), ZigBee, or nearfield communication (NFC).

The input/output interface 120 may include an input device (not shown) for receiving a command from a user and/or an output device (not shown) for outputting information to the user. For example, the input device may include a touch panel, a physical button, a microphone, or the like. For example, the output device may include a display device for outputting visual information, such as a display or a light-emitting diode (LED), an audio device for outputting auditory information, such as a speaker or a buzzer, a motor for outputting tactile information such as haptic effect, or the like.

The input/output interface 120 may transmit data corresponding to a command input by the user through the input device to another component (or other components) of the aerosol-generating device 100. The input/output interface 120 may output information corresponding to data received from another component (or other components) of the aerosol-generating device 100 through the output device.

The aerosol-generating module 130 may generate an aerosol from an aerosol-generating substance. Here, the aerosol-generating substance may be a substance in a liquid state, a solid state, or a gel state, which is capable of generating an aerosol, or a combination of two or more aerosol-generating substances.

According to an embodiment, the liquid aerosol-generating substance may be a liquid including a tobacco-containing material having a volatile tobacco flavor component. According to another embodiment, the liquid aerosol-generating substance may be a liquid including a non-tobacco material. For example, the liquid aerosol-generating substance may include water, solvents, nicotine, plant extracts, flavorings, flavoring agents, vitamin mixtures, etc.

The solid aerosol-generating substance may include a solid material based on a tobacco raw material such as a reconstituted tobacco sheet, shredded tobacco, or granulated tobacco. In addition, the solid aerosol-generating substance may include a solid material having a taste control agent and a flavoring material. For example, the taste control agent may include calcium carbonate, sodium bicarbonate, calcium oxide, etc. For example, the flavoring material may include a natural material such as herbal granules, or may include a material such as silica, zeolite, or dextrin, which includes an aroma ingredient.

In addition, the aerosol-generating substance may further include an aerosol-forming agent such as glycerin or propylene glycol.

The aerosol-generating module 130 may include at least one heater (not shown).

The aerosol-generating module 130 may include an electro-resistive heater. For example, the electro-resistive heater may include at least one electrically conductive track. The electro-resistive heater may be heated as current flows through the electrically conductive track. At this time, the aerosol-generating substance may be heated by the heated electro-resistive heater.

The electrically conductive track may include an electro-resistive material. In one example, the electrically conductive track may be formed of a metal material. In another example, the electrically conductive track may be formed of a ceramic material, carbon, a metal alloy, or a composite of a ceramic material and metal.

The electro-resistive heater may include an electrically conductive track that is formed in any of various shapes. For example, the electrically conductive track may be formed in any one of a tubular shape, a plate shape, a needle shape, a rod shape, and a coil shape.

The aerosol-generating module 130 may include a heater that uses an induction-heating method. For example, the induction heater may include an electrically conductive coil. The induction heater may generate an alternating magnetic field, which periodically changes in direction, by adjusting the current flowing through the electrically conductive coil. At this time, when the alternating magnetic field is applied to a magnetic body, energy loss may occur in the magnetic body due to eddy current loss and hysteresis loss. In addition, the lost energy may be released as thermal energy. Accordingly, the aerosol-generating substance located adjacent to the magnetic body may be heated. Here, an object that generates heat due to the magnetic field may be referred to as a susceptor.

Meanwhile, the aerosol-generating module 130 may generate ultrasonic vibrations to thereby generate an aerosol from the aerosol-generating substance.

The aerosol-generating device 100 may be referred to as a cartomizer, an atomizer, or a vaporizer.

The memory 140 may store programs for processing and controlling each signal in the controller 170, and may store processed data and data to be processed.

For example, the memory 140 may store applications designed for the purpose of performing various tasks that can be processed by the controller 170. The memory 140 may selectively provide some of the stored applications in response to the request from the controller 170.

For example, the memory 140 may store data on the operation time of the aerosol-generating device 100, the maximum number of puffs, the current number of puffs, the number of uses of battery 160, at least one temperature profile, at least one electric power profile, the user's inhalation pattern, and data about charging/discharging. Here, “puff” means inhalation by the user. “inhalation” means the user's act of taking air or other substances into the user's oral cavity, nasal cavity, or lungs through the user's mouth or nose.

The memory 140 may include at least one of volatile memory (e.g. dynamic random access memory (DRAM), static random access memory (SRAM), or synchronous dynamic random access memory (SDRAM)), nonvolatile memory (e.g. flash memory), a hard disk drive (HDD), or a solid-state drive (SSD).

The sensor module 150 may include at least one sensor.

For example, the sensor module 150 may include a sensor for sensing a puff (hereinafter referred to as a “puff sensor”). In this case, the puff sensor may be implemented as a proximity sensor such as an IR sensor, a pressure sensor, a gyro sensor, an acceleration sensor, a magnetic field sensor, or the like.

For example, the sensor module 150 may include a sensor for sensing a puff (hereinafter referred to as a “puff sensor”). In this case, the puff sensor may be implemented by a pressure sensor, a gyro sensor, an acceleration sensor, a magnetic field sensor, or the like.

For example, the sensor module 150 may include a sensor for sensing the temperature of the heater included in the aerosol-generating module 130 and the temperature of the aerosol-generating substance (hereinafter referred to as a “temperature sensor”). In this case, the heater included in the aerosol-generating module 130 may also serve as the temperature sensor. For example, the electro-resistive material of the heater may be a material having a predetermined temperature coefficient of resistance. The sensor module 150 may measure the resistance of the heater, which varies according to the temperature, to thereby sense the temperature of the heater.

For example, in the case in which the main body of the aerosol-generating device 100 is formed to allow a cigarette to be inserted thereinto, the sensor module 150 may include a sensor for sensing insertion of the cigarette (hereinafter referred to as a “cigarette detection sensor”).

For example, in the case in which the aerosol-generating device 100 includes a cartridge, the sensor module 150 may include a sensor for sensing mounting/demounting of the cartridge and the position of the cartridge (hereinafter referred to as a “cartridge detection sensor”).

In this case, the cigarette detection sensor and/or the cartridge detection sensor may be implemented as an inductance-based sensor, a capacitive sensor, a resistance sensor, or a Hall sensor (or Hall IC) using a Hall effect.

For example, the sensor module 150 may include a voltage sensor for sensing a voltage applied to a component (e.g. the battery 160) provided in the aerosol-generating device 100 and/or a current sensor for sensing a current.

The battery 160 may supply electric power used for the operation of the aerosol-generating device 100 under the control of the controller 170. The battery 160 may supply electric power to other components provided in the aerosol-generating device 100. For example, the battery 160 may supply electric power to the communication module included in the communication interface 110, the output device included in the input/output interface 120, and the heater included in the aerosol-generating module 130.

The battery 160 may be a rechargeable battery or a disposable battery. For example, the battery 160 may be a lithium-ion (Li-ion) battery, a lithium polymer (Li-polymer) battery or a lithium-ion phosphate battery. However, the present disclosure is not limited thereto. For example, the battery 160 may be a lithium cobalt oxide (LiCoO2) battery, a lithium titanate battery, and the like.

The aerosol-generating device 100 may further include a battery protection circuit module (PCM) (not shown), which is a circuit for protecting the battery 160. The battery protection circuit module (PCM) may be disposed adjacent to the upper surface of the battery 160. For example, in order to prevent overcharging and overdischarging of the battery 160, the battery protection circuit module (PCM) may cut off the electrical path to the battery 160 when a short circuit occurs in a circuit connected to the battery 160, when an overvoltage is applied to the battery 160, or when an overcurrent flows through the battery 160.

The aerosol-generating device 100 may further include a charging terminal to which electric power supplied from the outside is input. For example, the charging terminal may be formed at one side of the main body of the aerosol-generating device 100. The aerosol-generating device 100 may charge the battery 160 using electric power supplied through the charging terminal. In this case, the charging terminal may be configured as a wired terminal for USB communication, a pogo pin, or the like.

The aerosol-generating device 100 may further include a power terminal (not shown) to which electric power supplied from the outside is input. For example, a power line may be connected to the power terminal, which is disposed at one side of the main body of the aerosol-generating device 100. The aerosol-generating device 100 may use the electric power supplied through the power line connected to the power terminal to charge the battery 160. In this case, the power terminal may be a wired terminal for USB communication.

The aerosol-generating device 100 may wirelessly receive electric power supplied from the outside through the communication interface 110. For example, the aerosol-generating device 100 may wirelessly receive electric power using an antenna included in the communication module for wireless communication. The aerosol-generating device 100 may charge the battery 160 using the wirelessly supplied electric power.

The controller 170 may control the overall operation of the aerosol-generating device 100. The controller 170 may be connected to each of the components provided in the aerosol-generating device 100. The controller 170 may transmit and/or receive a signal to and/or from each of the components, thereby controlling the overall operation of each of the components.

The controller 170 may include at least one processor. The controller 170 may control the overall operation of the aerosol-generating device 100 using the processor included therein. Here, the processor may be a general processor such as a central processing unit (CPU). Of course, the processor may be a dedicated device such as an application-specific integrated circuit (ASIC), or may be any of other hardware-based processors.

The controller 170 may perform any one of a plurality of functions of the aerosol-generating device 100. For example, the controller 170 may perform any one of a plurality of functions of the aerosol-generating device 100 (e.g. a preheating function, a heating function, a charging function, and a cleaning function) according to the state of each of the components provided in the aerosol-generating device 100 and the user's command received through the input/output interface 120.

The controller 170 may control the operation of each of the components provided in the aerosol-generating device 100 based on data stored in the memory 140. For example, the controller 170 may control the supply of a predetermined amount of electric power from the battery 160 to the aerosol-generating module 130 for a predetermined time based on the data on the temperature profile, the electric power profile, and the user's inhalation pattern, which is stored in the memory 140.

The controller 170 may determine the occurrence or non-occurrence of a puff using the puff sensor included in the sensor module 150. For example, the controller 170 may check a temperature change, a flow change, a pressure change, and a voltage change in the aerosol-generating device 100 based on the values sensed by the puff sensor. The controller 170 may determine the occurrence or non-occurrence of a puff based on the value sensed by the puff sensor.

The controller 170 may control the operation of each of the components provided in the aerosol-generating device 100 according to the occurrence or non-occurrence of a puff and/or the number of puffs. For example, upon determining that a puff has occurred, the controller 170 may perform control such that electric power is supplied to the heater according to the electric power profile stored in the memory 140. For example, the controller 170 may perform control such that the temperature of the heater is changed or maintained based on the temperature profile stored in the memory 140.

The controller 170 may perform control such that the supply of electric power to the heater is interrupted according to a predetermined condition. For example, the controller 170 may perform control such that the supply of electric power to the heater is interrupted when the cigarette is removed, when the cartridge is demounted, when the number of puffs reaches the predetermined maximum number of puffs, when a puff is not sensed during a predetermined period of time or longer, or when the remaining capacity of the battery 160 is less than a predetermined value.

The controller 170 may calculate the remaining capacity with respect to the full charge capacity of the battery 160. For example, the controller 170 may calculate the remaining capacity of the battery 160 based on the values sensed by the voltage sensor and/or the current sensor included in the sensor module 150.

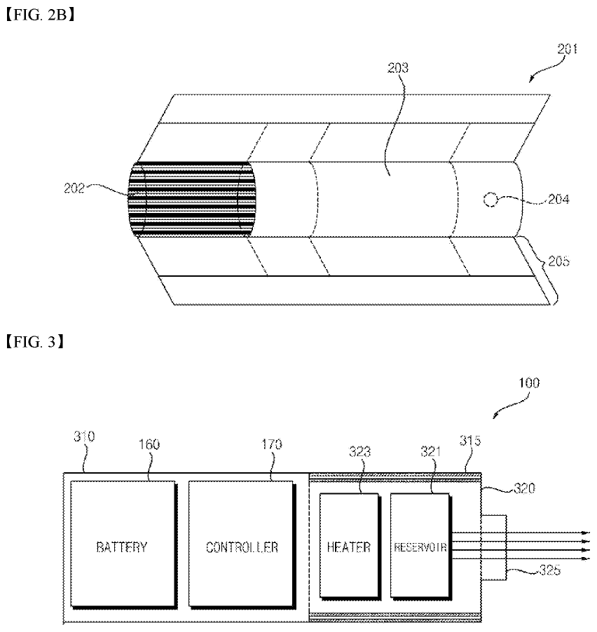

FIGS. 2A to 4 are views for explaining the aerosol-generating device according to embodiments of the present disclosure.

According to various embodiments of the present disclosure, the aerosol-generating device 100 may include a main body and/or a cartridge.

Referring to FIG. 2A, the aerosol-generating device 100 according to an embodiment may include a main body 210, which is formed such that a cigarette 201 can be inserted into the inner space formed by a housing 215.

The cigarette 201 may be similar to a general combustive cigarette. For example, the cigarette 201 may be divided into a first portion including an aerosol-generating substance and a second portion including a filter. Alternatively, the second portion of the cigarette 201 may also include an aerosol-generating substance. For example, a granular or capsular flavoring material may be inserted into the second portion.

The entirety of the first portion may be inserted into the aerosol-generating device 100. The second portion may be exposed to the outside. Alternatively, only a portion of the first portion may be inserted into the aerosol-generating device 100. Alternatively, the entirety of the first portion and a portion of the second portion may be inserted into the aerosol-generating device 100. The user may inhale the aerosol in the state of holding the second portion in the mouth. At this time, the aerosol may be generated as external air passes through the first portion. The generated aerosol may pass through the second portion to be introduced into the mouth of the user.

The main body 210 may be structured such that external air is introduced into the main body 210 in the state in which the cigarette 201 is inserted thereinto. In this case, the external air introduced into the main body 210 may flow into the mouth of the user via the cigarette 201.

When the cigarette 201 is inserted, the controller 170 may perform control such that electric power is supplied to the heater based on the temperature profile stored in the memory 140.

The controller 170 may perform control such that electric power is supplied to the heater using at least one of a pulse width modulation (PWM) method or a proportional-integral-differential (PID) method.

For example, the controller 170 may perform control such that a current pulse having a predetermined frequency and a predetermined duty ratio is supplied to the heater using the PWM method. In this case, the controller 170 may control the amount of electric power supplied to the heater by adjusting the frequency and the duty ratio of the current pulse.

For example, the controller 170 may determine a target temperature to be controlled based on the temperature profile. In this case, the controller 170 may control the amount of electric power supplied to the heater using the PID method, which is a feedback control method using a difference value between the temperature of the heater and the target temperature, a value obtained by integrating the difference value with respect to time, and a value obtained by differentiating the difference value with respect to time.

Although the PWM method and the PID method are described as examples of methods of controlling the supply of electric power to the heater, the present disclosure is not limited thereto, and may employ any of various control methods, such as a proportional-integral (PI) method or a proportional-differential (PD) method.

The heater may be disposed in the main body 210 at a position corresponding to the position at which the cigarette 201 is inserted into the main body 210. Although it is illustrated in the drawings that the heater is an electrically conductive heater 220 including a needle-shaped electrically conductive track, the present disclosure is not limited thereto.

The heater may heat the interior and/or exterior of the cigarette 201 using the electric power supplied from the battery 160. An aerosol may be generated from the heated cigarette 201. At this time, the user may hold one end of the cigarette 201 in the mouth to inhale the aerosol containing a tobacco material.

Meanwhile, the controller 170 may perform control such that electric power is supplied to the heater in the state in which the cigarette 201 is not inserted into the main body according to a predetermined condition. For example, when a cleaning function for cleaning the space into which the cigarette 201 is inserted is selected in response to a command input by the user through the input/output interface 120, the controller 170 may perform control such that a predetermined amount of electric power is supplied to the heater.

The controller 170 may monitor the number of puffs based on the value sensed by the puff sensor from the time point at which the cigarette 201 was inserted into the main body.

When the cigarette 201 is removed from the main body, the controller 170 may initialize the current number of puffs stored in the memory 140.

Referring to FIG. 2B, the cigarette 201 according to an embodiment may include a tobacco rod 202 and a filter rod 203. The first portion described above with reference to FIG. 2A may include the tobacco rod 202. The second portion described above with reference to FIG. 2A may include the filter rod 203.

Although it is illustrated in FIG. 2B that the filter rod 203 is composed of a single segment, the present disclosure is not limited thereto. In other words, the filter rod 203 may be composed of a plurality of segments. For example, the filter rod 203 may include a first segment configured to cool an aerosol and a second segment configured to remove a predetermined component included in the aerosol. In addition, the filter rod 203 may further include at least one segment configured to perform other functions, as needed.

The cigarette 201 may be packed using at least one wrapper 205. The wrapper 205 may have at least one hole formed therein to allow external air to be introduced thereinto or to allow internal gas to be discharged therefrom. In one example, the cigarette 201 may be packed using one wrapper 205. In another example, the cigarette 201 may be doubly packed using two or more wrappers 205. For example, the tobacco rod 202 may be packed using a first wrapper. For example, the filter rod 203 may be packed using a second wrapper. The tobacco rod 202 and the filter rod 203, which are individually packed using separate wrappers, may be coupled to each other. The entire cigarette 201 may be packed using a third wrapper. When each of the tobacco rod 202 and the filter rod 203 is composed of a plurality of segments, each segment may be packed using a separate wrapper. The entire cigarette 201, formed by coupling segments, each of which is packed using a separate wrapper, to each other, may be packed using another wrapper.

The tobacco rod 202 may include an aerosol-generating substance. For example, the aerosol-generating substance may include at least one of glycerin, propylene glycol, ethylene glycol, dipropylene glycol, diethylene glycol, triethylene glycol, tetraethylene glycol, or oleyl alcohol, but the present disclosure is not limited thereto. Also, the tobacco rod 202 may include other additives, such as a flavoring agent, a wetting agent, and/or an organic acid. Also, a flavoring liquid, such as menthol or a moisturizer, may be injected into and added to the tobacco rod 202.

The tobacco rod 202 may be manufactured in various forms. For example, the tobacco rod 202 may be formed as a sheet or a strand. For example, the tobacco rod 202 may be formed as shredded tobacco, which is formed by cutting a tobacco sheet into tiny bits. For example, the tobacco rod 202 may be surrounded by a thermally conductive material. For example, the thermally conductive material may be a metal foil such as aluminum foil, but the present disclosure is not limited thereto. In one example, the thermally conductive material surrounding the tobacco rod 202 may uniformly distribute heat transmitted to the tobacco rod 202, thereby improving conduction of the heat applied to the tobacco rod. This may improve the taste of the tobacco. The thermally conductive material surrounding the tobacco rod 202 may function as a susceptor that is heated by the induction heater. Here, although not illustrated in the drawings, the tobacco rod 202 may further include an additional susceptor, in addition to the thermally conductive material surrounding the tobacco rod 202.

The filter rod 203 may be a cellulose acetate filter. The filter rod 203 may be formed in any of various shapes. For example, the filter rod 203 may be a cylinder-type rod. For example, the filter rod 203 may be a hollow tube-type rod. For example, the filter rod 203 may be a recess-type rod. When the filter rod 203 is composed of a plurality of segments, at least one of the plurality of segments may be formed in a different shape.

The filter rod 203 may be formed to generate flavors. In one example, a flavoring liquid may be injected into the filter rod 203. In one example, a separate fiber coated with a flavoring liquid may be inserted into the filter rod 203.

In addition, the filter rod 203 may include at least one capsule 204. Here, the capsule 204 may function to generate a flavor. The capsule 204 may function to generate an aerosol. For example, the capsule 204 may have a structure in which a liquid containing a flavoring material is wrapped with a film. The capsule 204 may have a spherical or cylindrical shape, but the present disclosure is not limited thereto.

When the filter rod 203 includes a segment configured to cool the aerosol, the cooling segment may be made of a polymer material or a biodegradable polymer material. For example, the cooling segment may be made of pure polylactic acid alone, but the present disclosure is not limited thereto. Alternatively, the cooling segment may be formed as a cellulose acetate filter having a plurality of holes formed therein. However, the cooling segment is not limited to the above-described example, and any other type of cooling segment may be used, so long as the same is capable of cooling the aerosol.

Although not illustrated in FIG. 2B, the cigarette 201 according to an embodiment may further include a front-end filter. The front-end filter may be located at the side of the tobacco rod 202 that faces the filter rod 203. The front-end filter may prevent the tobacco rod 202 from becoming detached outwards. The front-end filter may prevent a liquefied aerosol from flowing into the aerosol-generating device 100 from the tobacco rod 202 during inhalation by the user.

Referring to FIG. 3, the aerosol-generating device 100 according to an embodiment may include a main body 310 and a cartridge 320. The main body 310 may support the cartridge 320, and the cartridge 320 may contain an aerosol-generating substance.

According to one embodiment, the cartridge 320 may be configured so as to be detachably mounted to the main body 310. According to another embodiment, the cartridge 320 may be formed integrally with the main body 310. For example, the cartridge 320 may be mounted to the main body 310 in a manner such that at least a portion of the cartridge 320 is inserted into the inner space formed by a housing 315 of the main body 310.

The main body 310 may be formed to have a structure in which external air can be introduced into the main body 310 in the state in which the cartridge 320 is inserted thereinto. Here, the external air introduced into the main body 310 may flow into the user's mouth via the cartridge 320.

The controller 170 may determine whether the cartridge 320 is in a mounted state or a detached state using a cartridge detection sensor included in the sensor module 150. For example, the cartridge detection sensor may transmit a pulse current through a terminal connected to the cartridge 320. In this case, the cartridge detection sensor may determine whether the cartridge 320 is in a connected state, based on whether the pulse current is received through another terminal.

The cartridge 320 may include a reservoir 321 configured to contain the aerosol-generating substance and/or a heater 323 configured to heat the aerosol-generating substance in the reservoir 321. For example, a liquid delivery element impregnated with (containing) the aerosol-generating substance may be disposed inside the reservoir 321. The electrically conductive track of the heater 323 may be formed in a structure that is wound around the liquid delivery element. In this case, when the liquid delivery element is heated by the heater 323, an aerosol may be generated. Here, the liquid delivery element may include a wick made of, for example, cotton fiber, ceramic fiber, glass fiber, or porous ceramic.

The cartridge 320 may include a mouthpiece 325. Here, the mouthpiece 325 may be a portion to be inserted into a user's oral cavity. The mouthpiece 325 may have a discharge hole through which the aerosol is discharged to the outside during a puff.

Referring to FIG. 4, the aerosol-generating device 100 according to an embodiment may include a main body 410 supporting the cartridge 420 and a cartridge 420 containing an aerosol-generating substance. The main body 410 may be formed so as to allow a cigarette 401 to be inserted into an inner space 415 therein.

The aerosol-generating device 100 may include a first heater for heating the aerosol-generating substance stored in the cartridge 420. For example, when the user holds one end of the cigarette 401 in the mouth to inhale the aerosol, the aerosol generated by the first heater may pass through the cigarette 401. At this time, while the aerosol passes through the cigarette 401, a tobacco material may be added to the aerosol. The aerosol containing the tobacco material may be drawn into the user's oral cavity through one end of the cigarette 401.

Alternatively, according to another embodiment, the aerosol-generating device 100 may include a first heater for heating the aerosol-generating substance stored in the cartridge 420 and a second heater for heating the cigarette 401 inserted into the main body 410. For example, the aerosol-generating device 100 may generate an aerosol by heating the aerosol-generating substance stored in the cartridge 420 and the cigarette 401 using the first heater and the second heater, respectively.

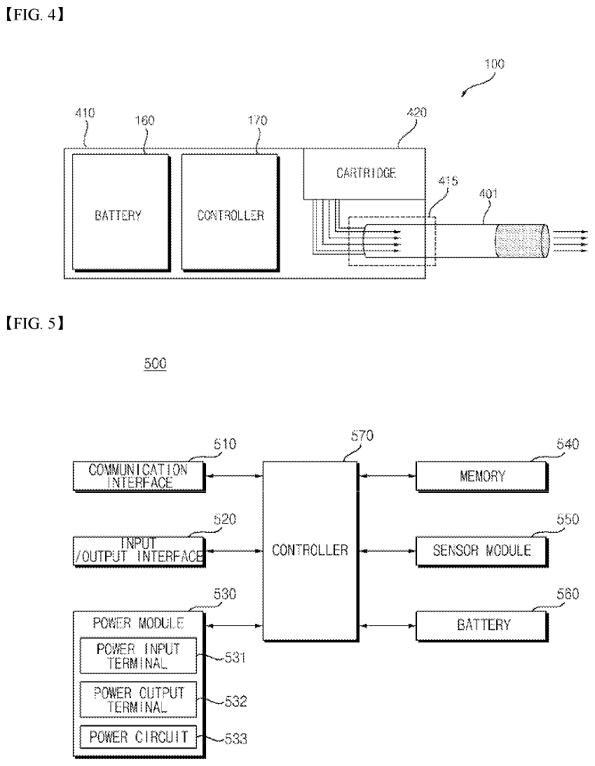

FIG. 5 is a block diagram of a power supply device according to an embodiment of the present disclosure.

Referring to FIG. 5, a power supply device 500 may include a communication interface 510, an input/output interface 520, a power module 530, a memory 540, a sensor module 550, a battery 560, and/or a controller 570.

The communication interface 510 may include at least one communication module for communication with an external device (e.g. the aerosol-generating device 100 shown in FIG. 1) and/or a network. For example, the communication interface 510 may include a communication module for wired communication, such as a Universal Serial Bus (USB). For example, the communication interface 510 may include a communication module for wireless communication, such as Wireless Fidelity (Wi-Fi), Bluetooth, Bluetooth Low Energy (BLE), ZigBee, or nearfield communication (NFC).

The input/output interface 520 may include an input device for receiving a command from a user and/or an output device for outputting information to the user. For example, the input device may include a touch panel, a physical button, or a microphone, or the like. For example, the output device may include a display device for outputting visual information, such as a display or a light-emitting diode (LED), an audio device for outputting auditory information, such as a speaker or a buzzer, or the like.

The input/output interface 520 may transmit data corresponding to a command input by the user through the input device to another component (or other components) of the power supply device 500. The input/output interface 520 may output information corresponding to data received from another component (or other components) of the power supply device 500 through the output device.

The power module 530 may supply power to respective components included in the power supply device 500. For example, the power module 530 may transmit power supplied from the outside to the battery 560. For example, the power module 530 may transmit power charged in the battery 560 to the controller 570, which may be implemented in a system-on-chip (SOC) form.

The power module 530 may include a power input unit (not shown) and/or a power output unit (not shown).

The power input unit may receive power supplied from the outside. For example, the power input unit may be formed outside the housing of the power supply device 500. The power input unit may include a power input terminal 531 (e.g. a USB communication terminal) capable of receiving power from a power line connected thereto.

The power output unit may output power to the outside of the power supply device 500. For example, the power output unit may be formed outside the housing of the power supply device 500. The power output unit may include a power output terminal 532 (e.g. a pogo pin) that contacts an external device.

The power module 530 may further include a power circuit 533 (not shown) for supplying power received from the outside to any one of the battery 560 and the power output unit.

The power circuit 533 may include at least one switching element, which operates in response to a control signal received from the controller 570. In this case, the power input from the outside through the power input unit may be transmitted to any one of the battery 560 and the power output unit according to the operation of the switching element. For example, the switching element may be implemented as a bipolar junction transistor (BJT), a field effect transistor (FET), or a relay, which operates in response to current flowing through a coil.

The power module 530 may receive power in a wireless manner. The power module 530 may output power in a wireless manner. For example, the power supply device 500 may receive power that is wirelessly supplied from the outside using an antenna included in the communication module of the communication interface 510. The power supply device 500 may supply power that is wirelessly supplied from the outside to the battery 560 through the power circuit. For example, the aerosol-generating device 100 may wirelessly output the power stored in the battery 560 to an external device using the antenna included in the communication module of the communication interface 510.

The memory 540 may store therein a program for processing and controlling each signal in the controller 570. The memory 540 may store therein processed data and data to be processed. For example, the memory 540 may store therein applications designed for the purpose of performing various tasks that can be processed by the controller 570. The memory 540 may selectively provide some of the stored applications in response to the request from the controller 570.

The memory 540 may include at least one of volatile memory (e.g. DRAM, SRAM, or SDRAM) or nonvolatile memory (e.g. flash memory, a hard disk drive (HDD), or a solid-state drive (SSD)).

The sensor module 550 may include at least one sensor.

For example, in the case in which mounting of an external device to the main body of the power supply device 500 is possible, the sensor module 550 may include a sensor for sensing mounting/demounting of the external device (hereinafter referred to as a “device detection sensor”). In this case, the device detection sensor may be implemented as an inductance-based sensor, a capacitive sensor, a resistance sensor, or a Hall sensor that uses a Hall effect.

For example, the sensor module 550 may include a voltage sensor for sensing the voltage applied to a component (e.g. the battery 560) provided in the power supply device 500 and/or a current sensor for sensing current.

The battery 560 may supply power used for operation of the power supply device 500 under the control of the controller 570. The battery 560 may supply power to other components provided in the power supply device 500. For example, the battery 560 may supply power to the communication module included in the communication interface 510, the output device included in the input/output interface 520, and the power output unit included in the power module 530.

The battery 560 may be a rechargeable battery or a disposable battery. For example, the battery 560 may be a lithium-ion battery or a lithium polymer (Li-polymer) battery. However, the present disclosure is not limited thereto. For example, when the battery 560 is rechargeable, the charging rate (C-rate) of the battery 560 may be 10 C, and the discharging rate (C-rate) thereof may be 10 C to 20 C. However, the present disclosure is not limited thereto. Also, for stable use, the battery 560 may be manufactured such that 80% or more of the original charging capacity is ensured even after charging/discharging is performed 2000 times.

The power supply device 500 may further include a battery protection circuit module (PCM) (not shown), which is a circuit for protecting the battery 560. For example, in order to prevent overcharging and overdischarging of the battery 560, the battery protection circuit module (PCM) may cut off the electrical path to the battery 560 when a short circuit occurs in a power circuit 533 connected to the battery 560, when overvoltage is applied to the battery 560, or when excessive current flows through the battery 560.

The controller 570 may control the overall operation of the power supply device 500. The controller 570 may be connected to each of the components provided in the power supply device 500. The controller 570 may transmit and/or receive a signal to and/or from each of the components, thereby controlling the overall operation of each of the components.

The controller 570 may include at least one processor. The controller 570 may control the overall operation of the power supply device 500 using the processor.

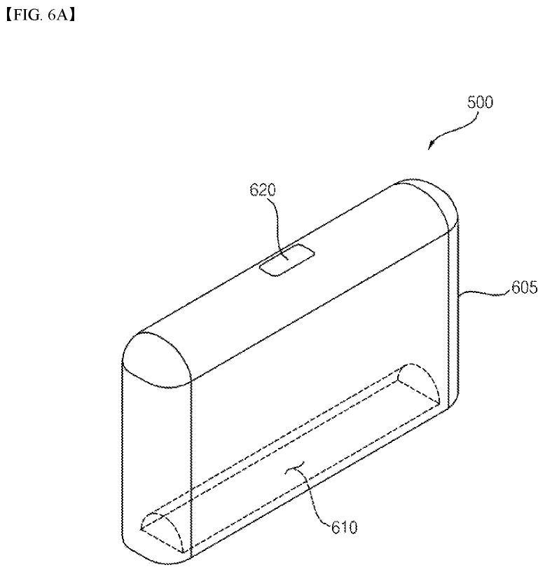

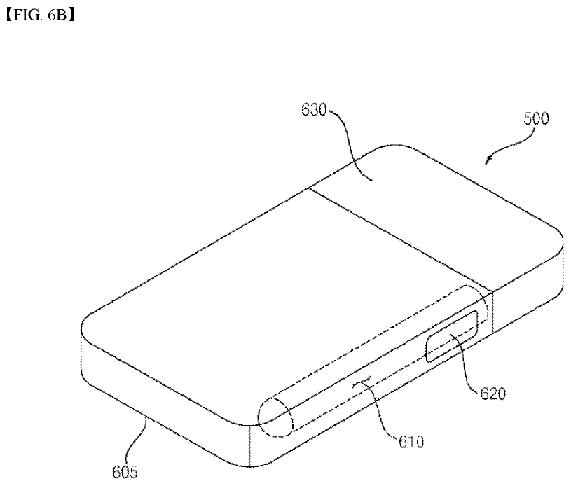

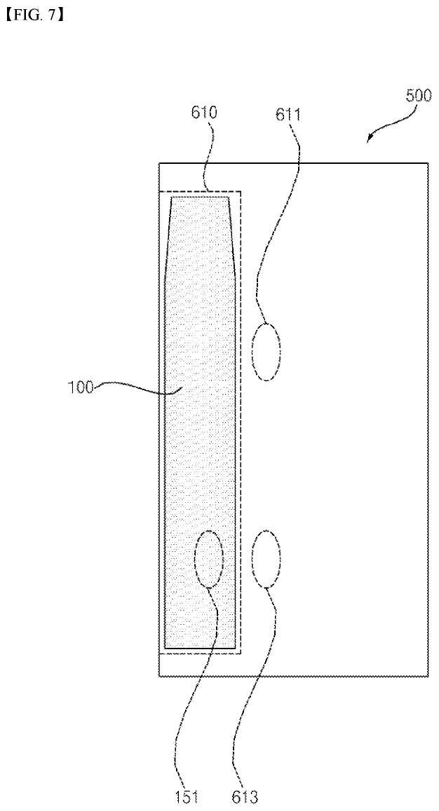

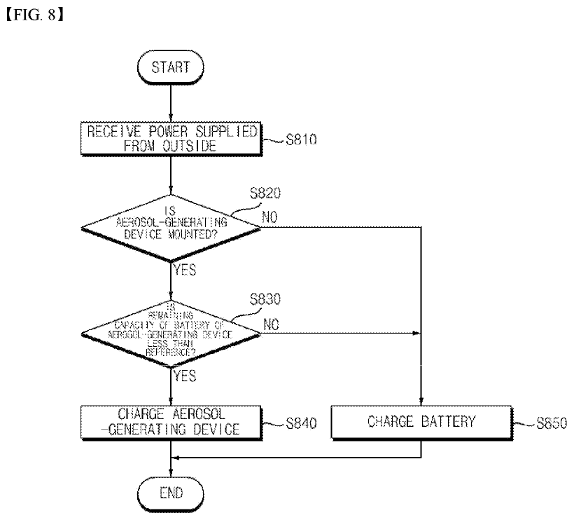

FIGS. 6A to 7 are views for explaining the power supply device according to embodiments of the present disclosure.

Referring to FIGS. 6A and 6B, an accommodation space 610, into which the aerosol-generating device 100 is inserted and/or mounted, may be formed inside or outside the housing 605 of the power supply device 500.

The aerosol-generating device 100, which is mounted to the power supply device 500, may be referred to as a holder, and the power supply device 500 may be referred to as a cradle. The battery 160 included in the aerosol-generating device 100 may be referred to as a holder battery or a device battery. The battery 560 included in the power supply device 500 may be referred to as a cradle battery or a power supply battery.

An input device 620 (e.g. a button) for receiving a command from a user may be disposed outside the housing 605 of the power supply device 500.

Similar to what is illustrated in FIG. 6A, in an example, the aerosol-generating device 100 may be inserted into and fixed in an accommodation space 610, which is formed outside the housing 605 of the power supply device 500, without a separate opening/closing member (e.g. a lid).

Alternatively, similar to what is illustrated in FIG. 6B, in another example, the power supply device 500 may include a separate opening/closing member 630. In this case, after the aerosol-generating device 100 is inserted into the accommodation space 610 formed inside the housing 605 of the power supply device 500, the opening/closing member 630 is closed, whereby the aerosol-generating device 100 may be fixed in the accommodation space 610.

FIG. 7 illustrates an example in which the aerosol-generating device 100 is inserted into the power supply device 500.

The accommodation space 610 may be formed in one surface of the power supply device 500 in consideration of the length and height of the aerosol-generating device 100. When the aerosol-generating device 100 is mounted in the power supply device 500, the aerosol-generating device 100 may be prevented from being exposed to the outside by the other surfaces of the power supply device 500.

The power supply device 500 may include one or more bonding members 611 and 613 for increasing the bonding strength with the aerosol-generating device 100. In addition, the aerosol-generating device 100 may include at least one bonding member 151 corresponding to the bonding members 611 and 613 of the power supply device 500.

Here, each of the bonding members 151, 611, and 613 may be implemented as a magnet, but the present disclosure is not limited thereto. In addition, the number of bonding members provided in each of the aerosol-generating device 100 and the power supply device 500 may vary depending on the embodiment.

The bonding member 151 included in the aerosol-generating device 100 may be located at a first position. The bonding members 611 and 613 included in the power supply device 500 may be located at a second position and a third position, respectively. In this case, the first position and the third position may be positions at which the two bonding members 151 and 613 face each other when the aerosol-generating device 100 is inserted into the power supply device 500.

Due to the bonding members 151, 611, and 613 included in the aerosol-generating device 100 and the power supply device 500, when the aerosol-generating device 100 is inserted into one surface of the power supply device 500, the aerosol-generating device 100 and the power supply device 500 may be strongly bonded to each other. Accordingly, even if the power supply device 500 is not provided with a separate opening/closing member 630, e.g. a lid, the aerosol-generating device 100, once inserted into the power supply device 500, may not be easily separated therefrom.

The device detection sensor included in the sensor module 550 of the power supply device 500 may be composed of the terminal (e.g. the pogo pin) included in the power output unit of the power module 530 and the bonding members 611 and 613. For example, the device detection sensor may sense mounting/demounting of an external device based on the current flowing through the terminal of the power output unit, the voltage applied to the terminal of the power output unit, and changes in the magnetic fields of the bonding members 611 and 613.

Also, the controller 570 of the power supply device 500 may determine mounting/demounting of the aerosol-generating device 100 based on the signal received from the device detection sensor. The controller 570 of the power supply device 500 may control the components based on the result of the determination on mounting/demounting of the aerosol-generating device 100. For example, when the aerosol-generating device 100 is mounted, the controller 570 of the power supply device 500 may transmit the power stored in the battery 560 to the aerosol-generating device 100. For example, when the aerosol-generating device 100 is demounted, the controller 570 of the power supply device 500 may interrupt the supply of power to the aerosol-generating device 100.

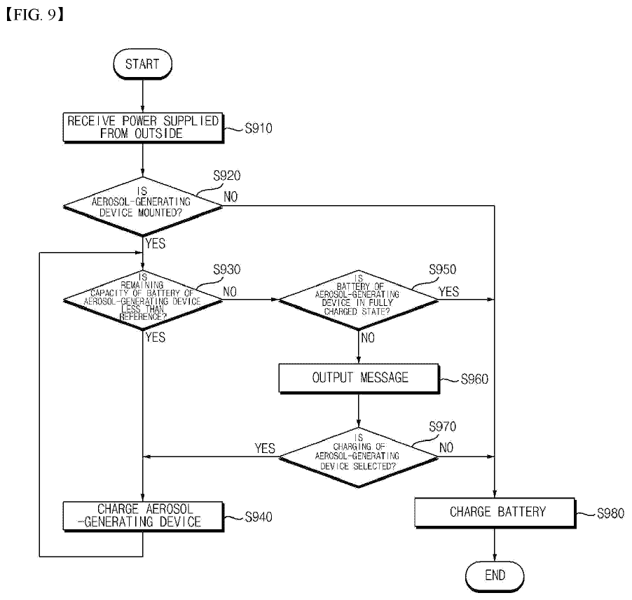

FIG. 8 is a flowchart showing an operation method of the power supply device according to an embodiment of the present disclosure.

The power supply device 500 may receive power supplied from the outside in operation S810. For example, the power supply device 500 may receive power from a power line connected thereto through the power input unit included in the power module 530.

The power supply device 500 may determine whether the aerosol-generating device 100 is in a mounted state based on the signal received through the device detection sensor in operation S820. For example, the power supply device 500 may determine whether the aerosol-generating device 100 is in a mounted state based on the current flowing through the terminal (e.g. the pogo pin) included in the power output unit.

When the aerosol-generating device 100 is in a mounted state, the power supply device 500 may determine whether the remaining capacity of the battery 160 of the aerosol-generating device 100 is less than a predetermined reference capacity in operation S830. For example, the power supply device 500 may receive data on the remaining capacity of the battery 160 from the aerosol-generating device 100 through the communication interface 510. For example, the power supply device 500 may determine whether the remaining capacity of the battery 160 of the aerosol-generating device 100 is less than the reference capacity based on the received data.

Here, the reference capacity may be set differently according to setting by the user. For example, the reference capacity may be set to a remaining capacity (e.g. 100%) of the battery 160 corresponding to a fully charged state or a remaining capacity (e.g. 50%) of the battery 160 corresponding to minimal use by the user, for example, complete consumption of an aerosol-generating substance contained in one cigarette.

Alternatively, the aerosol-generating device 100 may generate data on the reference capacity based on the inhalation pattern of the user, and may transmit the data to the power supply device 500. The power supply device 500 may set the reference capacity based on the data on the reference capacity received from the aerosol-generating device 100.

The aerosol-generating device 100 may calculate the amount of power consumed by the heater (e.g. the heater 200 shown in FIG. 2A) during a time period from the time of start of use by the user to the time of end of use by the user. For example, the aerosol-generating device 100 may calculate the amount of power consumed by the heater (e.g. the heater 200 shown in FIG. 2A) during a time period from the time of insertion of the cigarette (e.g. the cigarette 201 shown in FIG. 2B) to the time of removal of the cigarette. In this case, the aerosol-generating device 100 may generate data on the reference capacity corresponding to the calculated amount of power, and may transmit the data to the power supply device 500.

When the remaining capacity of the battery 160 of the aerosol-generating device 100 is less than the reference capacity, the power supply device 500 may charge the battery 160 of the aerosol-generating device 100 with the power supplied from the outside in operation S840. For example, when the remaining capacity of the battery 160 of the aerosol-generating device 100 is less than the reference capacity (e.g. 50%), the switching element included in the power circuit 533 may operate such that the power supplied from the outside through the power input unit is transmitted to the terminal included in the power output unit.

When the aerosol-generating device 100 is in a removed state, or when the remaining capacity of the battery 160 of the aerosol-generating device 100 is equal to or greater than the reference capacity, the power supply device 500 may charge the battery 560 of the power supply device 500 with the power supplied from the outside in operation S850. For example, when the aerosol-generating device 100 is in a removed state, the switching element included in the power circuit 533 may operate such that the power supplied from the outside through the power input unit is transmitted to the battery 560.

The power supply device 500 may repeatedly perform operations S820 to S850 while power is supplied from the outside. For example, the power supply device 500 may continuously monitor whether the aerosol-generating device 100 is mounted and whether the remaining capacity of the battery 160 of the aerosol-generating device 100 is less than the reference capacity. For example, the power supply device 500 may perform an operation corresponding to the result of monitoring.

FIG. 9 is a flowchart showing an operation method of the power supply device according to another embodiment of the present disclosure. A detailed description of the same content as that described with reference to FIG. 8 will be omitted.

Referring to FIG. 9, the power supply device 500 may receive power supplied from the outside in operation S910.

The power supply device 500 may determine whether the aerosol-generating device 100 is in a mounted state based on the signal received through the device detection sensor in operation S920.

When the aerosol-generating device 100 is in a mounted state, the power supply device 500 may determine whether the remaining capacity of the battery 160 of the aerosol-generating device 100 is less than the reference capacity in operation S930.

When the remaining capacity of the battery 160 of the aerosol-generating device 100 is less than the reference capacity, the power supply device 500 may charge the battery 160 of the aerosol-generating device 100 with the power supplied from the outside in operation S940.

When the remaining capacity of the battery 160 of the aerosol-generating device 100 is equal to or greater than the reference capacity, the power supply device 500 may determine whether the battery 160 is in a fully charged state in operation S950. For example, the power supply device 500 may determine whether the remaining capacity of the battery 160 of the aerosol-generating device 100 is 100%.

When the battery 160 of the aerosol-generating device 100 is not in a fully charged state, for example, when the remaining capacity of the battery 160 is less than 100%, the power supply device 500 may output a message prompting to select one of charging of the aerosol-generating device 100 and charging of the battery 560 through the output device included in the input/output interface 520 in operation S960.

For example, the power supply device 500 may turn on at least one of the light-emitting diodes (LEDs) included in the output device in order to indicate that the remaining capacity of the battery 160 of the aerosol-generating device 100 is equal to or greater than the reference capacity (e.g. 50%).

For example, the power supply device 500 may output, through the display included in the output device, a message prompting to select one of charging of the aerosol-generating device 100 and charging of the battery 560.

The power supply device 500 may determine whether charging of the aerosol-generating device 100 is selected among charging of the aerosol-generating device 100 and charging of the battery 560 in operation S970. For example, the power supply device 500 may receive user input for selecting one of charging of the aerosol-generating device 100 and charging of the battery 560 through the input device (e.g. the button 620) included in the input/output interface 520.

When charging of the aerosol-generating device 100 is selected, the process proceeds to operation S940, and the power supply device 500 may continue to charge the battery 160 of the aerosol-generating device 100.

When the battery 160 of the aerosol-generating device 100 is preset to be preferentially charged to a fully charged state, when charging of the aerosol-generating device 100 is selected, or when the battery 560 is in a fully charged state, the power supply device 500 may omit output of a message prompting to select an object to be charged. In this case, the power supply device 500 may continue to charge the battery 160 of the aerosol-generating device 100.

When the power supply device 500 does not receive user input for selecting one of charging of the aerosol-generating device 100 and charging of the battery 560 through the input device during a predetermined time period, the power supply device 500 may determine that charging of the aerosol-generating device 100 has been selected.

When the aerosol-generating device 100 is in a removed state, when the battery 160 of the aerosol-generating device 100 is in a fully charged state, or when the battery 560 is preset to be preferentially charged, the power supply device 500 may charge the battery 560 of the power supply device 500 with the power supplied from the outside in operation S980.

As described above, according to at least one of the embodiments of the present disclosure, power supplied from the outside may be appropriately supplied to the aerosol-generating device 100 in consideration of the state (e.g. remaining capacity) of the battery 160 of the aerosol-generating device 100.

Referring to FIGS. 1 to 9, a power supply device 500 according to an aspect of the present disclosure may include a housing 605 having formed therein an accommodation space, a power supply battery 560, a power input terminal 531 configured to receive power supplied from the outside, a power output terminal 532 configured to output power to an aerosol-generating device 100 accommodated in the accommodation space, a power circuit 533 configured to transmit the power received through the power input terminal 531 to one of the power supply battery 560 and the power output terminal, and a controller 570 configured to control the operation of the power circuit. The controller 570 may determine the remaining capacity of a device battery 160 included in the aerosol-generating device 100. When the remaining capacity is less than a predetermined reference capacity, the controller 570 may control the power circuit 533 to transmit the power received through the power input terminal 531 to the power output terminal. When the remaining capacity is equal to or greater than the reference capacity, the controller 570 may control the power circuit 533 to transmit the power received through the power input terminal 531 to the power supply battery.

In addition, in accordance with another aspect of the present disclosure, the power circuit 533 may include at least one switching element, and the controller 570 may control the operation of the at least one switching element to transmit the power received through the power input terminal 531 to one of the power supply battery 560 and the power output terminal.

In addition, in accordance with another aspect of the present disclosure, the power supply device 500 may further include a communication interface 510 configured to perform communication with the aerosol-generating device 100. The controller 570 may determine the remaining capacity of the device battery 160 based on data on the charged state of the aerosol-generating device 100 received through the communication interface 510.

In addition, in accordance with another aspect of the present disclosure, the reference capacity may be a charging capacity of the device battery 160 corresponding to minimal use of the aerosol-generating device 100 by a user.

In addition, in accordance with another aspect of the present disclosure, the power supply device 500 may further include an input device configured to receive user input and an output device configured to output a message. When the remaining capacity of the device battery 160 is equal to or greater than the reference capacity, the controller 570 may output a message prompting to select one of the power supply battery 560 and the device battery 160 through the output device, and may control the operation of the power circuit 533 in response to the user input received through the input device.

In addition, in accordance with another aspect of the present disclosure, the power supply device may further include an input device configured to receive user input. When the remaining capacity of the device battery 160 is equal to or greater than the reference capacity, the controller 570 may determine whether the user input is received through the input device during a predetermined time period. When the user input is not received, the controller 570 may control the operation of the power circuit 533 to transmit the power received through the power input terminal 531 to the power output terminal. When the user input is received, the controller 570 may control the operation of the power circuit 533 to transmit the power received through the power input terminal 531 to the power supply battery 560.

An aerosol-generating system according to an aspect of the present disclosure may include an aerosol-generating device 100 and a power supply device 500. The power supply device 500 may include a housing 605 having an accommodation space formed therein to accommodate the aerosol-generating device 100, a power supply battery 560, a power input terminal 531 configured to receive power supplied from the outside, a power output terminal 532 configured to output power to the aerosol-generating device 100 accommodated in the accommodation space, a power circuit 533 configured to transmit the power received through the power input terminal 531 to one of the power supply battery 560 and the power output terminal, and a first controller 570 configured to control the operation of the power circuit 533 based on the remaining capacity of a second battery 160 included in the aerosol-generating device 100. The aerosol-generating device 100 may include a heater, a device battery 160 configured to supply power to the heater, and a second controller 170. The first controller 570 may determine the remaining capacity of the device battery 160. When the remaining capacity is less than a predetermined reference capacity, the first controller 570 may control the power circuit 533 to transmit the power received through the power input terminal 531 to the aerosol-generating device through the power output terminal. When the remaining capacity is equal to or greater than the reference capacity, the first controller 570 may control the power circuit 533 to transmit the power received through the power input terminal 531 to the power supply battery.

In addition, in accordance with another aspect of the present disclosure, the power supply device 500 may further include a first communication interface 510 configured to perform communication with the aerosol-generating device 100, and the aerosol-generating device 100 may further include a second communication interface 110 configured to perform communication with the power supply device 500. The second controller 170 may calculate the amount of power consumed by the heater during a time period from the time of start of use by a user to the time of end of use by the user, may generate data on the reference capacity based on the calculated amount of power, and may transmit the data on the reference capacity to the power supply device 500 through the second communication interface 110. The first controller 570 may set the reference capacity based on the data on the reference capacity received through the first communication interface 510.

Certain embodiments or other embodiments of the disclosure described above are not mutually exclusive or distinct from each other. Any or all elements of the embodiments of the disclosure described above may be combined with another or combined with each other in configuration or function.

For example, a configuration “A” described in one embodiment of the disclosure and the drawings and a configuration “B” described in another embodiment of the disclosure and the drawings may be combined with each other. Namely, although the combination between the configurations is not directly described, the combination is possible except in the case where it is described that the combination is impossible.

Although embodiments have been described with reference to a number of illustrative embodiments thereof, it should be understood that numerous other modifications and embodiments can be devised by those skilled in the art that will fall within the scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

1. A power supply device comprising:
a housing having formed therein an accommodation space;
a power supply battery;
a power input terminal configured to receive externally supplied power;
a power output terminal configured to output power to an aerosol-generating device accommodated in the accommodation space;
a power circuit configured to transmit the power received through the power input terminal to one of the power supply battery or the power output terminal; and
a controller configured to control operation of the power circuit,
wherein the controller is configured to:
determine a remaining capacity of a device battery included in the aerosol-generating device,
based on the remaining capacity being less than a predetermined reference capacity, control the power circuit to transmit the power received through the power input terminal to the power output terminal, and
based on the remaining capacity being equal to or greater than the reference capacity, control the power circuit to transmit the power received through the power input terminal to the power supply battery.

2. The power supply device according to claim 1, wherein the power circuit comprises at least one switching element, and
wherein the controller is configured to control operation of the at least one switching element to selectively transmit the power received through the power input terminal to one of the power supply battery or the power output terminal.

3. The power supply device according to claim 1, further comprising:
a communication interface configured to perform communication with the aerosol-generating device,
wherein the controller is configured to determine the remaining capacity of the device battery based on data on a charged state of the aerosol-generating device received through the communication interface.

4. The power supply device according to claim 1, wherein the reference capacity is a charging capacity of the device battery corresponding to minimal use of the aerosol-generating device by a user.

5. The power supply device according to claim 1, further comprising:
an input device configured to receive user input; and
an output device configured to output a message,
wherein the controller is configured to:
based on the remaining capacity of the device battery being equal to or greater than the reference capacity, output a message prompting to select one of the power supply battery and the device battery through the output device, and
control operation of the power circuit in response to the user input received through the input device.

6. The power supply device according to claim 1, further comprising:
an input device configured to receive user input,
wherein controlling the power circuit to transmit the power to the power supply battery based on the remaining capacity being equal to or greater than the reference capacity is further based on receiving a user input through the input device during a predetermined time period, and
based on the remaining capacity being equal to or greater than the reference capacity and the user input not being received during the predetermined time period, the controller is configured to control operation of the power circuit to transmit the power received through the power input terminal to the power output terminal.

7. An aerosol-generating system comprising a power supply device and an aerosol-generating device, wherein the power supply device comprises:
a housing having an accommodation space formed therein to accommodate the aerosol-generating device;
a power supply battery;
a first controller;
a power input terminal configured to receive externally supplied power;
a power output terminal configured to output power to the aerosol-generating device accommodated in the accommodation space; and
a power circuit configured to transmit the power received through the power input terminal to one of the power supply battery or the power output terminal
wherein the aerosol-generating device comprises:
a heater;
a device battery configured to supply power to the heater; and
a second controller, and
wherein the first controller is configured to:
determine a remaining capacity of the device battery,
based on the remaining capacity being less than a predetermined reference capacity, control the power circuit to transmit the power received through the power input terminal to the aerosol-generating device through the power output terminal, and
based on the remaining capacity being equal to or greater than the reference capacity, control the power circuit to transmit the power received through the power input terminal to the power supply battery.

8. The aerosol-generating system according to claim 7, wherein the power circuit comprises at least one switching element, and
wherein the first controller is configured to control operation of the at least one switching element to selectively transmit the power received through the power input terminal to one of the power supply battery or the power output terminal.

9. The aerosol-generating system according to claim 7, wherein the power supply device further comprises a first communication interface configured to perform communication with the aerosol-generating device,
wherein the aerosol-generating device further comprises a second communication interface configured to perform communication with the power supply device,
wherein the second controller is configured to transmit data on a charged state including the remaining capacity of the device battery to the power supply device through the second communication interface, and
wherein the first controller is configured to determine the remaining capacity of the device battery based on the transmitted data on the charged state received through the first communication interface.

10. The aerosol-generating system according to claim 7, wherein the reference capacity is a charging capacity of the device battery corresponding to minimal use of the aerosol-generating device by a user.

11. The aerosol-generating system according to claim 7, wherein the power supply device further comprises a first communication interface configured to perform communication with the aerosol-generating device,
wherein the aerosol-generating device further comprises a second communication interface configured to perform communication with the power supply device,
wherein the second controller is configured to:
calculate an amount of power consumed by the heater from a use start time to a use end time by a user,
generate data for the reference capacity based on the calculated amount of power, and
transmit the data for the reference capacity to the power supply device through the second communication interface, and
wherein the first controller is configured to set the reference capacity based on the data for the reference capacity received through the first communication interface.

12. The aerosol-generating system according to claim 7, wherein the power supply device further comprises:
an input device configured to receive user input; and
an output device configured to output a message,
wherein the first controller is configured to:
based on the remaining capacity of the device battery being equal to or greater than the reference capacity, output a message through the output device prompting to select one of the power supply battery or the device battery, and
control operation of the power circuit based on a user input received through the input device in response to the outputted message.

13. The aerosol-generating system according to claim 7, wherein the power supply device further comprises an input device configured to receive user input,
wherein controlling the power circuit to transmit the power received through the power input terminal to the power supply battery based on the remaining capacity being equal to or greater than the reference capacity is further based on receiving a user input through the input device during a predetermined time period
based on the remaining capacity being equal to or greater than the reference capacity and the user input not being received during the predetermined time period, the first controller is configured to control operation of the power circuit to transmit the power received through the power input terminal to the power output terminal.
